(19) United States
(12) Patent Application Publication
(10) Pub. No.: US 2023/0371601 A1
(43) Pub. Date: Nov. 23, 2023

(54) Aerosol Generating Device with a Plurality of Identical Ring-Shaped Susceptors

(71) Applicant: JT International S.A., Geneva (CH)

(72) Inventor: Mark Gill, London (GB)

(73) Assignee: JT International SA, Geneva (CH)

(21) Appl. No.: 18/029,976

(22) PCT Filed: Oct. 4, 2021
(86) PCT No.: PCT/EP2021/077311

§ 371 Date: Apr. 3, 2023

(30) Foreign Application Priority Data
Oct. 6, 2020 (EP) 20200315.8

(51) Int. Cl. A24F 40/465; A24F 40/20; H05B 6/10

(52) U.S. Cl. CPC A24F 40/465; A24F 40/20; H05B 6/105

(57) ABSTRACT

An aerosol generating device includes
a cylindrical heating cavity mainly extending in an axial direction, for receiving a vaporizable stick containing a substance suitable for being vaporized upon heating to produce an inhalable vapor,
a heater at least partially surrounding the cylindrical heating cavity,
and a magnetic field generator configured to generate a varying magnetic field through the heater to heat the heater by induction.

The heater comprises includes a plurality of identical ring-shaped susceptors arranged along the axial direction, each ring-shaped susceptor encircling the cylindrical heating cavity.

Such a segmented heater may provide either an even heating of the whole stick or a temperature distribution along the axial direction for selectively heat parts of the stick.

### FIELD OF THE INVENTION

The present disclosure relates to an aerosol generating device, such as a heated tobacco device, which creates an inhalable vapor by heating though not burning a stick containing tobacco and/or other substrates suitable for being converted into an inhalable vapor when heated.

### BACKGROUND OF THE INVENTION

An aerosol generating device generally includes: a box containing a microcontroller; a user interface for bilateral communication with the microcontroller; a battery; an atomizer containing a chamber for receiving a vaporizable stick of a substance suitable to be heated to generate an inhalable vapor (for example a tobacco-containing stick) and an electrical heater powered by the battery and controlled by the microcontroller for heating the stick by conduction, convection and/or radiation.

The vaping experience depends on various parameters such as the maximum power delivered to the heater by the battery, the maximum temperature of the heater, the ramp-up (rise time to reach the desired maximum temperature), the inlet air flow, etc. These parameters may be set differently according to the substrate to be vaporized and/or according to the used material and/or according to the user's mood and wishes. The vaping device may be controlled according to various modes, for example a temperature mode where the microcontroller controls the temperature of the heater and adjust the power delivered to the heater according to the current temperature of the heater to reach set point values of temperature.

When the tobacco device is turned on, it is desirable to provide a fast heating of the stick to avoid a long wait before beginning to vape. Later, it might be desirable to provide a stable low heating of the stick to be able to vape for a long time.

Thus it is desirable to make it possible to vary over time the temperature of any part in the stick or to vary over time the average temperature of the stick. It might also be desirable to make it possible to locally vary the temperature of a part of the stick or to vary the distribution of the heat in the stick.

It might also be desirable to make it possible to partially heat the stick or to selectively heat parts of the stick, for various reasons.

Meanwhile, it might also be desirable to provide an even heating of the whole stick at a specific moment or for a long time.

In brief, it is desirable to provide a heated tobacco device having an easily adjustable heater.

Besides, aerosol generating device having heaters heated by induction are known. WO2017036955 discloses an example of heated tobacco device using heater elements heated by induction.

The induction heated tobacco device of WO2017036955 does not make it possible to create various temperature distributions in the tobacco stick in particular along the axial direction of the stick.

The invention aims to solve at least one of the above-mentioned problem, with a simple arrangement easy to implement and to miniaturize and easy to control.

### SUMMARY OF THE INVENTION

The invention proposes an aerosol generating device including:
a cylindrical heating cavity mainly extending in an axial direction, for receiving a vaporizable stick containing a substance suitable for being vaporized upon heating to produce an inhalable vapor,
a heater at least partially surrounding the cylindrical heating cavity,
and a magnetic field generator configured to generate a varying magnetic field through the heater to heat the heater by induction,

characterized in that the heater comprises a plurality of identical ring-shaped susceptors arranged along the axial direction, each ring-shaped susceptor encircling the cylindrical heating cavity.

In other words, the heater comprises a segmented susceptor arrangement, made of a succession of identical ring-shaped susceptors. Such ring-shaped susceptors are optimized for efficient induction heating and, since they are identical, they can produce even heating whereby a localized overheating is avoided.

On the other hand, the ring-shaped susceptors can also create a temperature gradient along the axial direction of the stick, to have low spots and higher spots in the stick while avoiding hot spots which are detrimental to the vaporizable material.

Thanks to this, the aerosol generating device may be used with a stick made of a succession of identical or different sections, each section corresponding to one (or maybe two) ring-shaped susceptors.

In particular, the aerosol generating device may be used with a tobacco stick made of multiple sections with different components made of different tobacco materials which would need to be heated preferentially at different frequencies, therefore different temperatures for vaporization. The user could enjoy different flavors experience in that way with a single stick. Such a stick may be heated entirely, with a temperature distribution showing different temperatures respective to the different sections of the stick; alternatively, if possible or needed, the stick may be heated entirely with an even temperature distribution (that is to say with an identical temperature in the whole stick), this being possible since the ring-shaped susceptors are identical.

As another example, the stick might be made of multiple sections, identical or not, intended to be heated at different time periods, therefore providing long lasting sensory experience, or a user might want not to vape the whole stick at once and might then decide to vape only partially the stick with the intention to vape another part thereof later. Then, only one or more sections may be heated. All the sections of the stick may thus be heated successively, either at the same temperature or at different temperature (by adapting the magnetic field created by the generator).

It is to be noted that the aerosol generating device according to the invention may be used with a vaporizable stick also known as “consumable”. Such a consumable comprises a solid stick, that is to say a stick made of a solid vaporizable material. It broadly looks like a conventional cigarette, having a tubular region with a vaporizable material arranged in a suitable manner. Filter, vapor collection regions, cooling regions and other structure may also be included in some designs. An outer layer of paper or other flexible planar material such as foil may also be provided, for example to hold the solid vaporizable material in place, which further the resemblance to a conventional cigarette.

But the invention is not limited to such a consumable. It may be used with any stick of vaporizable material, where the expression “vaporizable material” designates any material that is vaporizable in air to form an aerosol. Vaporization is generally obtained by a temperature increase up to a temperature which corresponds to the boiling point of the vaporizable material, in particular a temperature up to 400° C., preferably up to 350° C. The vaporizable material may, for example, comprise or consist of tobacco derivatives, expanded tobacco, tobacco extract, homogenized tobacco, tobacco substitutes or any combinations thereof; it may also comprise or consist of an aerosol-generating liquid, gel or wax or the like.

The aerosol generating device according to the invention may thus be used not only with a stick made of solid vaporizable material(s), but also with a stick which includes liquid or gel or the like, the liquid or gel being for example retained in a solid matrix or contained in a pod forming the entire stick or forming a section of the stick (the stick may then comprise a combination of solid sections and of liquid or viscous sections in the form of pods filled with a liquid or viscous vaporizable material).

Moreover, as better explained in the detailed description, the invention applies not only to an aerosol generating device configured to receive a solid stick of the kind that includes a mouthpiece or of the kind that resemble to a conventional cigarette as above described, but also to an aerosol generating device configured to receive a vaporizable stick of the kind pod or capsule or tablet which is devoid of mouthpiece (in that second case, the aerosol generating device comprises a mouthpiece fixedly or removably attached to an atomizing part of the aerosol generating device). In other embodiments, the heating cavity may be arranged to receive the vaporizable stick in other forms, such as loose tobacco or tobacco packaged in other ways.

According to a possible feature, the ring-shaped susceptors have an inner diameter smaller than the outer diameter of the cylindrical heating cavity, whereby each ring-shaped susceptor applies a pressure on the vaporizable stick received in the cylindrical heating cavity.

Alternatively or in addition, the ring-shaped susceptors have inner protrusions on an inner face, to add compression on the vaporizable stick received in the cylindrical heating cavity.

Alternatively or in addition, the ring-shaped susceptors have a convex inner face, whereby showing a varying inner diameter, with a minimum inner diameter smaller than the outer diameter of the cylindrical heating cavity. Again, such a ring-shaped susceptor applies a pressure on the vaporizable stick received in the cylindrical heating cavity.

In all these alternative embodiments, adding compression on the vaporizable stick helps locking the vaporizable stick in place and preventing it from sliding around. It also optimizes the thermal contact/transfer between the ring-shaped susceptors and the vaporizable stick.

According to a possible feature, the ring-shaped susceptors have a convex top or bottom edge, to create a temperature gradient within each ring-shaped susceptor.

According to a possible feature, the ring-shaped susceptors are spaced apart each other with a same spacing distance in the axial direction.

Alternatively, the ring-shaped susceptors are spaced apart each other with different spacing distances along the axial direction. This creates an axial temperature gradient in the cylindrical heating cavity along the axial direction if the susceptors are all simultaneously and equally heated by the magnetic field generator.

According to a possible feature, the ring-shaped susceptors have a width and a height in the axial direction which are higher than a thickness of the ring-shaped susceptors in a radial direction.

In the whole specification, the expression “width of a susceptor” means the dimension of the ring-shaped susceptor in the axial direction, that is to say the distance between the top edge and the bottom edge of the susceptor in the axial direction. If the ring-shaped susceptor has a convex top or bottom edge, the width of the susceptor is the maximum distance between the top edge and the bottom edge in the axial direction. The expression “height of the susceptor” means the distance between the transverse plane which contains the highest point of the susceptor and the transverse plane which contains the lowest point of the susceptor, a transverse plane being a plane orthogonal to the axial direction.

The width and the height of a susceptor may be the same, for example if the bottom and top edges of the susceptor extend in parallel transverse planes. The width and the height of a susceptor may be different, for example in the case of ring-shaped susceptors in the form of wave rings as described here after. For a susceptor being a wave ring having parallel top and bottom corrugated edge with crests and troughs, the width is the distance (in the axial direction) between the parallel edges at any point thereof, that is to say for example the distance in the axial direction between a trough of the top edge and the facing trough of the bottom edge (or, which is the same, between a crest of the top edge and the facing crest of the bottom edge). The height of such a wave ring susceptor is the distance in the axial direction between the transverse plane containing the crests (or the highest crest) of the top edge and the transverse plane containing the troughs (or the lower trough) of the bottom edge. Therefore, in such a wave ring susceptor, the height of the susceptor is greater than the width of the susceptor.

In a possible embodiment, the ring-shaped susceptors are in the number of six, have a width of about 2-3 mm in the axial direction and a thickness of about 0.1-0.3 mm in a radial direction, the ring-shaped susceptors being spaced apart from each other preferably with a same spacing distance of 0.5-1 mm in the axial direction.

According to a possible feature, the ring-shaped susceptors are connected together by a plurality of insulating axial rods fastened to an outer face of the ring-shaped susceptors. In this case, the spacing distance between two successive susceptors cannot be varied.

According to a possible feature, at least one of the ring-shaped susceptors is arranged to be movable along the axial direction to selectively heat parts of the cylindrical heating cavity. The other susceptors may be linked together by insulating rods or not.

According to a possible feature, the aerosol generating device includes means for axially moving the vaporizable stick received in the cylindrical heating cavity. To this end, the aerosol generating device may comprise a member configured to engage the vaporizable stick and to be operated, automatically or manually by the user, for moving the vaporizable stick along the axial direction in the cylindrical heating cavity.

According to a possible feature, the magnetic field generator of the heating tobacco device is configured to heat simultaneously all the ring-shaped susceptors. To this end, for example, the magnetic field generator comprises a coil which has a height in the axial direction enough to encircle all the ring-shaped susceptors, whereby all the susceptors are simultaneously heated when the coil is supplied with a varying current.

Alternatively, the magnetic field generator of the heating tobacco device is configured to heat simultaneously only some of the ring-shaped susceptors, in order to create a variable heating distribution along the length of the tobacco stick (that is to say along the axial direction).

To this end, the magnetic field generator comprises for example:
a tubular housing configured to encircle the cylindrical heating cavity and the ring-shaped susceptors, an upper part of the tubular housing bearing a coil which extends axially along only a part of the length (in the axial direction) of the cylindrical heating cavity, the tubular housing further having a threaded inner face,
a fixed motor having a shaft which drives a threaded nut which is coupled to the threaded inner face of the tubular housing whereby the rotation of the nut causes the tubular housing to move axially.

Thanks to the tubular housing, the motor and the nut, the coil is movable along the axial direction (towards the upper end or the lower end of the cylindrical heating cavity depending on the sense of rotation of the nut) and it may be first placed at the height of one or more susceptors and next moved along the axial direction to face one or more other susceptors, whereby different parts of the tobacco stick are successively heated.

According to a first embodiment, the ring-shaped susceptors are mere frustum of cylinder, having planar, preferably parallel, top and bottom edges.

According to a second embodiment, the ring-shaped susceptors are each formed of a closed wave ring having corrugated (non-planar) top and bottom edges with crests and troughs. These top and bottom corrugated edges are preferably parallel.

According to a possible feature, all or some of these wave rings touch each other to form a multi-turn wave set. This makes it possible to create zones of different temperatures in the cylindrical heating cavity, hotter areas being provided where two wave rings touch each other.

According to a possible feature, the wave rings have a width great enough such that the wave crests of the bottom edge are located under, in the axial direction, the wave troughs of the top edge, the wave rings thus showing a plain straight central band. A rapid and efficient heat delivery by inductive heating is achieved at this central band when the wave ring is energized and distribution of heat over a wider surface area is next achieved when the wave ring is de-energized, by flowing of the heat from the central band to the edges of the wave ring.

According to a possible feature, whatever their shape (frustum of cylinder or wave ring), the ring-shaped susceptors are made of a low carbon steel. Low carbon steels allow for very efficient transfer of energy (when converting the electro-magnetic field into heat).

### BRIEF DESCRIPTION OF THE DRAWINGS

Other particularities and advantages of the invention will also emerge from the following description.

In the accompanying drawings, given by way of non-limiting examples:

FIG. 1 represents a side view of an aerosol generating device according to a first embodiment of the invention;

FIG. 2 represents a schematic axial cross section of the first embodiment of FIG. 1, where the coil of the magnetic field generator is in a highest position;

FIG. 3 represents a schematic axial cross section of the first embodiment of FIGS. 1 and 2 where the coil of the magnetic field generator is in a lowest position;

FIG. 4 represents an axial cross section of a first embodiment of a ring-shaped susceptor according to the invention;

FIG. 5 represents an axial cross section of a second embodiment of a ring-shaped susceptor according to the invention;

FIG. 6 represents an axial cross section of a third embodiment of a ring-shaped susceptor according to the invention;

FIG. 7 represents an axial cross section of a fourth embodiment of a ring-shaped susceptor according to the invention;

FIG. 8 represents an axial cross section of a fifth embodiment of a ring-shaped susceptor according to the invention;

FIG. 9 represent a side view of an assembly of ring-shaped susceptors according to FIG. 8.

### DETAILED DESCRIPTION

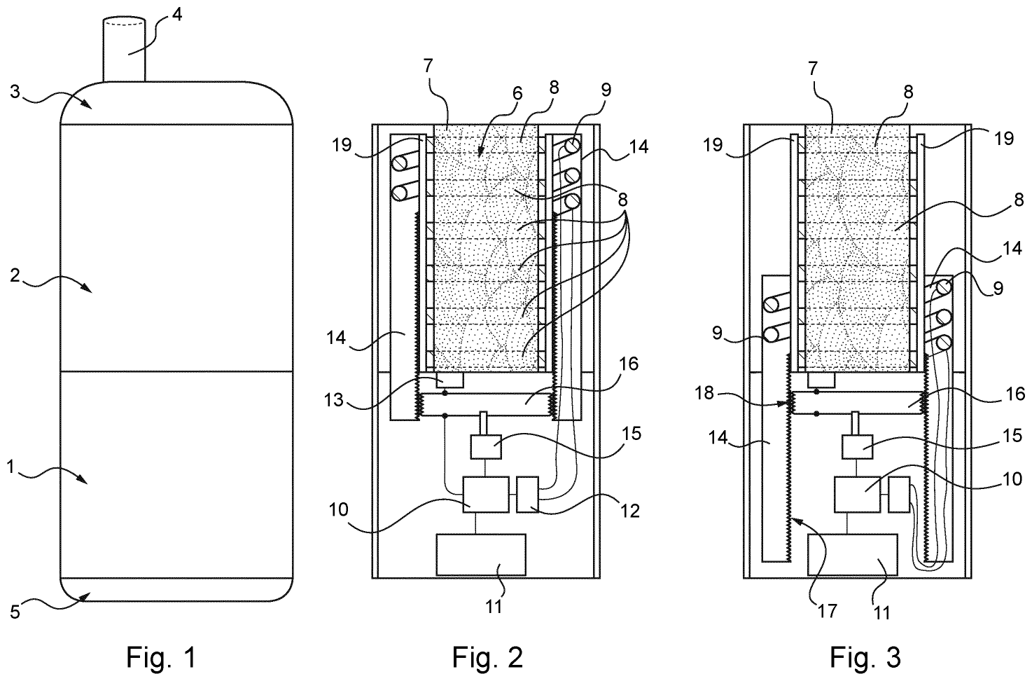

The aerosol generating device according to the invention illustrated at FIGS. 1 to 3 comprises a controlling and powering part 1, an atomizing part 2, a cap 3, a mouthpiece 4 where a user may place his mouth to vape, and a base 5.

The controlling and powering part 1 accommodates a battery 11 (see FIGS. 2 and 3) and a number of electronic components including a microcontroller 10 in the form of a main printed circuit board assembly. The microcontroller 10 is connected to the battery 11 and powered by the latter in a conventional way (schematically represented by a connecting line). At the bottom end of the controlling and powering part 1, the base 5 may include connecting means (not shown) for connecting the battery 11 to a charger (not shown) supplied with electricity by a suitable transformer or by a USB (Universal Serial Bus) socket.

The atomizing part 2 includes a heating cylindrical cavity 6 for receiving a vaporizable stick. The heating cylindrical cavity 6 is open at the top end of the atomizing part 2 to allow the user to engage a stick 7 in the heating cylindrical cavity 6 once the cap 3 is removed. This can be observed at FIGS. 2 and 3 where the cap 3 and the mouthpiece 4 are omitted (the base 5 is also omitted at these two figures). In other embodiments, the cap 3 may also include the mouthpiece, in other terms the cap may constitute the mouthpiece. In FIG. 1 the mouthpiece 4 is ex-centered, in some embodiment, the mouthpiece 4 can be centrally placed on the cap, i.e. longitudinally aligned with the heating cavity.

It is to be noted that the stick 7 illustrated at FIGS. 2 and 3 is in the form of a pod where a vaporizable material is embedded. The invention is not limited to this kind of stick. The invention also applies to solid sticks, in particular tobacco sticks that resemble to conventional cigarettes as described above, which already include a mouthpiece. In such solid sticks, the upper end of the stick serves as or is equipped with a mouthpiece. In that case, the aerosol generating device according to the invention is devoid of mouthpiece 4 as illustrated; instead, the cap 3 is provided with a central opening through which the upper end (mouthpiece) of the stick can pass and protrude to allow the user to vape.

The aerosol generating device further comprises a heater in the atomizing part 2. According to the invention, the heater includes a plurality of identical ring-shaped susceptors 8 encircling the heating cylindrical cavity 6, made of an electrically conductive material such as a metallic material or a low carbon steel. In the example illustrated at FIGS. 2 and 3, the heater includes six closed ring-shaped susceptors, which are spaced apart from each other with a same spacing distance and which are connected and secured in the atomizing part 2 by a plurality (for example four) of insulating rods 19.

Preferably the ring-shaped susceptors are closed, with no gap, since a gap would induce an electric arc which seems not desirable. Moreover, the ring-shaped susceptors are preferably configured with no change in the electrical resistance on their outer face to provide a continuous current pathway to get an even flow of energy within the susceptor. A break in the current pathway would cause a reduction in the energy delivered as heat. A sudden change of resistance at one point would cause massive localized overheating which may act like a fuse and burn out at this point (especially with thin materials).

The heater of the aerosol generating device further comprises a varying magnetic field generator, here including a coil 9 accommodated in an insulating tubular housing 14 which surrounds the ring-shaped susceptors 8 with the insulating rods 19. The coil 9 is powered by an alternative current-delivering component 12 controlled and supplied by the microcontroller 10.

In the illustrated example, the coil 9 does not extend axially along the whole length of the heating cylindrical cavity 6; it only extends along a part thereof such that it faces only two or three susceptors 8. Besides, the tubular housing has a threaded inner face 17, and the heater further includes a motor 15 and a nut 16 which has a threaded outer face 18 able to engage the threaded inner face 16 of the tubular housing. The nut 16 is mounted on a shaft of the motor 15, this latter being fixed in the aerosol generating device. So the operation of the motor 15 causes the nut 16 to rotate causing the tubular housing 14 and the coil 9 to move axially. The tubular housing 14 and the coil 9 are represented in their highest position at FIG. 2 and in their lowest position at FIG. 3.

In the attached drawings, the tubular housing has a double wall (that is to say an inner wall, whose inner face 17 is threaded, and an outer wall, whose faces are cylindrical) and the coil is accommodated inside the double wall. Alternatively, the tubular housing may be made of a single wall, having a threaded inner face at the lower part thereof, and the coil may be fastened to the outer face of this single wall at the upper part thereof.

The controlling and powering part 1 may comprise one or more temperature sensors for measuring the temperature at various spots at the periphery of the heating cylindrical cavity 6 along the axial direction, including the temperature sensor 13 configured to measure the temperature at the bottom end of the heating cylindrical cavity. These measures may be used to control the movements of the tubular housing 14 to adapt in real time the position of the coil according to the current distribution of temperatures in the heating cylindrical cavity 6 along the axial direction. Alternatively, the movements of the coil 9 may follow a preprogrammed pattern, which may depend on the nature of the vaporizable stick present in the cavity or which may be chosen by the user among various proposed patterns corresponding to various vaping experiences.

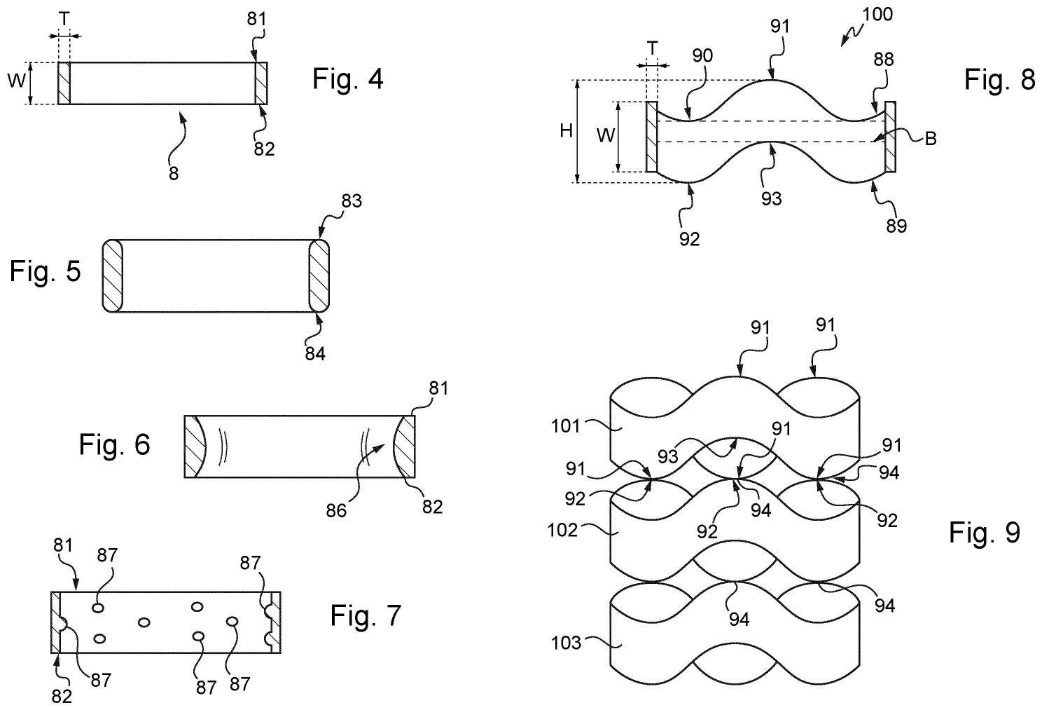

FIGS. 4 to 8 show different kinds of ring-shaped susceptor which are convenient for the implementation of the invention.

The ring-shaped susceptor 8 represented at FIG. 4 (and at FIGS. 2 and 3) is a mere frustum of cylinder having a circular cross section, a top edge 81 contained in a first transverse plane and a bottom edge 82 contained in a second transverse plane. The top and bottom edges are thus both planar and parallel. This ring-shaped susceptor has a thickness T in a radial direction which is lesser than the width W of the susceptor in the axial direction.

The ring-shaped susceptor represented at FIG. 5 is also a frustum of cylinder having a circular cross section, but it has a convex top edge 83 and a convex bottom edge 84.

The ring-shaped susceptor represented at FIG. 6 has a cylindrical outer face, a top edge 81 contained in a first transverse plane and a bottom edge 82 contained in a second transverse plane, as the ring-shaped susceptor 8 represented at FIG. 4. However, contrary to this latter, the ring-shaped susceptor of FIG. 6 has a convex inner face 86 likely to apply a pressure on the vaporizable stick.

As the ring-shaped susceptor 8 represented at FIG. 4, the ring-shaped susceptor represented at FIG. 7 is a frustum of cylinder with a circular cross section, having a top edge 81 contained in a first transverse plane and a bottom edge 82 contained in a second transverse plane. However, contrary to the susceptor 8, the cylindrical inner face of the ring-shaped susceptor represented at FIG. 7 is provided with protrusions 87 which locally add compression on the vaporizable stick.

The ring-shaped susceptor 100 illustrated at FIG. 8 is a wave ring having cylindrical outer and inner faces and having parallel corrugated top edge 88 and bottom edge 89 with crests 91, 93 and troughs 90, 92. All the crests 91 of the top edge 88 are contained in a first transverse plane, all the troughs 90 of the top edge 88 are contained in a second transverse plane. Likewise, all the crests 93 of the bottom edge 89 are contained in a third transverse plane, and all the troughs 92 of the bottom edge 89 are contained in a fourth transverse plane.

The width W of the wave ring is the distance between the top edge 88 and the bottom edge 89 in the axial direction (in any axial section). The height H of the wave ring is the distance between the first transverse plane (which contains the crests 91 of the top edge 88) and the fourth transverse plane (which contains the troughs 92 of the bottom edge 89). Preferably, the width W of the wave ring is greater than its thickness (dimension in a radial direction). Indeed, the thicker the wave ring is, the greater the thermal mass is. Thus a thicker ring would require more energy to heat to the same temperature as a thinner ring; moreover, the heat-up time would be increased with a thicker ring, which is generally not desirable. Besides, a reasonably large width provides the optimal field path for induction heating and also maximizes the contact surface area with the vaporizable stick.

Advantageously, the troughs 90 of the top edge 88 are located above the crests 93 of the bottom edge 89, whereby a plain straight central band B extends (in the axial direction) between the second transverse plane (which contains the troughs 90 of the top edge 88) and the third transverse plane (which contains the crests 93 of the bottom edge 89), where a rapid and efficient heat delivery by inductive heating is achieved when the wave ring is energized.

The FIG. 9 shows an assembly where three wave rings 101-103 identical to the wave ring 100 of FIG. 8 are arranged close to each other to form a multi-turn wave set where the troughs 92 of the bottom edge of the first wave ring 100 touch the crests 91 of the top edge of the second wave ring 101, creating contact points 94. Likewise, contact points 94 are created by contacting the troughs of the bottom edge of the second wave ring 101 with the crests of the top edge of the third wave ring 102. Hotter spots (but not burning spots) are thus provided in the tobacco stick at the contact points 94.

An aerosol generating device comprising a plurality of wave rings 100 spaced apart from each other along the heating cylindrical cavity is in compliance with the invention. An aerosol generating device comprising at least one multi-turn wave set such as the one illustrated at FIG. 9 and one or more other waves rings spaced apart each other and spaced apart the multi-turn wave set is also in compliance with the invention. Likewise, an aerosol generating device comprising a plurality of multi-turn wave sets spaced apart each other is also in compliance with the invention. Besides, this latter might comprise multi-turn wave sets having the same number of wave rings or multi-turn wave sets which do not have the same number of wave rings.

The invention extends to all the alternative embodiments that are covered by the appended claims.

In particular, the axially movable coil 9 may be replaced by a fixed coil, associated with means for axially (manually or automatically) moving the tobacco stick. For example, the aerosol generating device may comprise a cylindrical hollow extending from the top end of the aerosol generating device and having a length in the axial direction of almost twice the length of the tobacco stick 7. The cylindrical hollow shows an upper part having a height of about the length of the tobacco stick and a lower part having a height of almost the length of the tobacco stick.

The cylindrical hollow is provided with a sliding plate configured to receive the bottom end of the tobacco stick and to be axially moved in this cylindrical hollow. An anchoring element might protrude from the upper face of the sliding plate to engage the stick such as to secure the stick to the sliding plate. The sliding pate is configured to be axially moved automatically or manually between a highest position and a lowest position. When the sliding plate is in its highest position, the sliding plate is situated at the junction between the upper part and the lower part of the cylindrical hollow (in other words, the sliding plate is situated at or a little bit under the mid-height of the cylindrical hollow). When the sliding plate is in its highest position, the tobacco stick fills the upper part of the cylindrical hollow (the top end of the tobacco stick is flush with the top end of the cylindrical hollow). When the sliding plate is in its lowest position, the sliding plate is situated at the bottom end of the cylindrical hollow and the tobacco stick fills the lower part of the cylindrical hollow.

The fixed coil may be arranged just above the junction between the upper and the lower part of the cylindrical hollow such as to heat at least a lower part of the tobacco stick when the sliding plate is in its highest position. The portion of the cylindrical hollow which is surrounded by the fixed coil corresponds to the claimed cylindrical heating cavity. When the sliding plate is moved downwardly, the fixed coil ends up to face and heat upper parts of the tobacco stick; when the sliding pate is at its lowest position, the fixed coil ends up to face and heat the top end of the tobacco stick.

The skilled person in the art may envision various embodiments to move automatically the sliding plate, without taking an inventive step. For example, the lower face of the sliding plate might be fastened to the end of a small piston extending in the axial direction of the cylindrical hollow under the sliding plate.

In the above example, since the cylindrical hollow has a height greater than the illustrated cylindrical heating cavity 6, it might be necessary to accommodate some of the elements constituting the controlling and powering part 1 elsewhere, for example around the upper part of the cylindrical hollow, above or around the fixed coil.

Back to the illustrated embodiments (with a non-moving tobacco stick), it is also possible to provide a fixed coil extending along the entire length of the cylindrical heating cavity or preferably a plurality of fixed coils, each coil facing one or two susceptors, the coils being independently connected to the alternative current-delivering member 12 such as to allow to power simultaneously all the coils or only one of them.

### LIST OF REFERENCES

1: powering part
2: atomizing part
3: cap
4: mouthpiece
5: base
6: cylindrical heating cavity
7: vaporizable stick
8: ring-shaped susceptors
81: top edge
82: bottom edge
83: (convex) top edge
84: (convex) bottom edge
86: (convex) inner face
87: protrusions
88: (corrugated) top edge
89: (corrugated) bottom edge
90: top edge troughs
91: top edge crests
92: bottom edge troughs
93: bottom edge crests
94: contact points
9: coil
10: microcontroller
11: battery
12: current-delivering component
13: temperature sensor
14: tubular housing
15: motor
16: nut
10 17: tubular housing inner face
18: nut outer face
19: insulating rods
100-103: wave rings
B: central band

1. Aerosol generating device including:
a cylindrical heating cavity mainly extending in an axial direction, for receiving a vaporizable stick containing a substance configured for being vaporized upon heating to produce an inhalable vapor,
a heater at least partially surrounding the cylindrical heating cavity, and
a magnetic field generator configured to generate a varying magnetic field through the heater to heat the heater by induction,
wherein the heater comprises a plurality of identical ring-shaped susceptors arranged along the axial direction, each ring-shaped susceptor encircling the cylindrical heating cavity.

2. The aerosol generating device according to claim 1, wherein the ring-shaped susceptor have an inner diameter smaller than an outer diameter of the cylindrical heating cavity.

3. The aerosol generating device according to claim 1, wherein the ring-shaped susceptors have inner protrusions on an inner face.

4. The aerosol generating device according to claim 1, wherein the ring-shaped susceptors have a convex inner face, whereby showing a varying inner diameter, with a minimum inner diameter smaller than an outer diameter of the cylindrical heating cavity.

5. The aerosol generating device according to claim 1, wherein the ring-shaped susceptors have a convex top or bottom edge.

6. The aerosol generating device according to claim 1, wherein the ring-shaped susceptors are spaced apart each other with a same spacing distance in the axial direction of the cylindrical heating cavity.

7. The aerosol generating device according to claim 1, wherein the ring-shaped susceptors are spaced apart each other with different spacing distances along the axial direction.

8. The aerosol generating device according to claim 1, wherein the ring-shaped susceptors have a width (W) and a height in the axial direction which are higher than a thickness (T) of the ring-shaped susceptors in a radial direction.

9. The aerosol generating device according to claim 1, wherein the ring-shaped susceptors are in the number of six, have a width of about 2-3 mm in the axial direction and a thickness of about 0.1-0.3 mm in a radial direction, the ring-shaped susceptors spaced apart from each other with a same spacing distance of about 0.5-1 mm in the axial direction.

10. The aerosol generating device according to claim 1, wherein the ring-shaped susceptors are connected together by a plurality of insulating axial rods fastened to an outer face of the ring-shaped susceptors.

11. The aerosol generating device according to claim 1, wherein at least one of the ring-shaped susceptors is arranged to be movable along the axial direction.

12. The aerosol generating device according to claim 1, further comprising a member configured to engage a vaporizable stick received in the cylindrical heating cavity and to be operated for moving the vaporizable stick along the axial direction in the cylindrical heating cavity.

13. The aerosol generating device according to claim 1, wherein the magnetic field generator comprises:
a coil extending axially along only a part of a length of the cylindrical heating cavity,
a tubular housing configured to encircle the cylindrical heating cavity and the ring-shaped susceptors, an upper part of the tubular housing bearing said coil the tubular housing further having a threaded inner face, and
a fixed motor having a shaft configured to drive a threaded nut which is coupled to the inner face of the tubular housing whereby the rotation of the threaded nut causes the tubular housing with the coil to move axially.

14. The aerosol generating device according to claim 1, wherein the ring-shaped susceptors are each formed of a closed wave ring having corrugated top and bottom edges with crests and troughs.

15. The aerosol generating device according to claim 14, wherein all or some of these wave rings touch each other to form a multi-turn wave set.

16. The aerosol generating device according to claim 14, wherein the wave rings have a width (W) great enough such that the wave crests of the bottom edge are located under in the axial direction the wave troughs of the top edge, the wave rings thus showing a plain straight central band (B).

17. The aerosol generating device according to claim 1, wherein the ring-shaped susceptors are made of a low carbon steel.
